(19) United States
(12) Patent Application Publication
(10) Pub. No.: US 2025/0252333 A1
(43) Pub. Date: Aug. 7, 2025

(54) SYSTEMS AND METHODS FOR MANAGING STATES OF DATA OBJECTS USING ENTANGLEMENT IN A QUANTUM NETWORK

(71) Applicant: BANK OF AMERICA CORPORATION, Charlotte, NC (US)

(72) Inventors: Saurabh Arora, Gurugram, Haryana (IN); Sandeep Chauhan, Hyderabad, Telangana (IN); Anil Gajula, Hyderabad, Telangana (IN); Jhalak Khurana, Hisar, Haryana (IN)

(73) Assignee: BANK OF AMERICA CORPORATION, Charlotte, NC (US)

(21) Appl. No.: 18/434,403

(22) Filed: Feb. 6, 2024

(51) Int. Cl. G06N 10/40

(52) U.S. Cl. CPC G06N 10/40

(57) ABSTRACT

Systems, computer program products, and methods are described herein for managing states of data objects using entanglement in a quantum network. Some embodiments are directed to a system that identifies, for a data object including sub-objects, a critical sub-object of the data object, where a first data center stores a first copy of the data object, and where a second data center stores a second copy of the data object. The system may entangle, in response to identifying the critical sub-object, the first copy of the critical sub-object and the second copy of the critical sub-object on a quantum network. The system may detect a change to the first copy of the critical sub-object and update, in response to detecting the change, the second copy of the critical sub-object via the quantum network to implement the detected change.

### TECHNOLOGICAL FIELD

Example embodiments of the present disclosure relate to systems and methods for managing states of data objects using entanglement in a quantum network.

### BACKGROUND

In order to maintain consistency in application outputs through various channel applications, data consistency and timely availability should be maintained across data centers/clusters/zones. Various techniques may be employed in an effort to ensure that data updated in one data center/cluster/zone is replicated in other data centers/clusters/zones.

### BRIEF SUMMARY

Systems, methods, and computer program products are provided for managing states of data objects using entanglement in a quantum network.

In one aspect, the present invention is directed to a system for managing states of data objects using entanglement in a quantum network. The system may include a first network interface configured to communicate via a quantum network and a second network interface configured to communicate via a communication network. The system may include a non-transitory storage device including computer program code stored thereon and a processing device operably coupled to the first network interface, the second network interface, and the non-transitory storage device. The computer program code may include computer instructions configured to cause the processing device to identify, for a data object including sub-objects, a critical sub-object of the data object, where a first data center stores a first copy of the data object including a first copy of the critical sub-object, and where a second data center stores a second copy of the data object including a second copy of the critical sub-object. The computer program code may include computer instructions configured to cause the processing device to entangle, using the first network interface and in response to identifying the critical sub-object, the first copy of the critical sub-object and the second copy of the critical sub-object on the quantum network. The computer program code may include computer instructions configured to cause the processing device to detect, using the second network interface, a change to the first copy of the critical sub-object stored in the first data center and update, using the first network interface and in response to detecting the change, the second copy of the critical sub-object stored in the second data center via the quantum network to implement the detected change.

In some embodiments, the computer program code may include computer instructions configured to cause the processing device to identify additional critical sub-objects of a plurality of objects having copies stored on a plurality of data centers including the first data center and the second data center.

In some embodiments, the first data center may provide access to data objects for applications executed by a first plurality of devices located in a first geographical region, and the second data center may provide access to the data objects for the applications executed by a second plurality of devices located in a second geographical region that is different from the first geographical region.

In some embodiments, the first data center may provide access to data objects for applications executed by a first plurality of devices of a first type, and the second data center may provide access to the data objects for the applications executed by a second plurality of devices of a second type that is different from the first type.

In some embodiments, the first data center may provide access to data objects for first applications, and the second data center may provide access to the data objects for second applications that are different from the first applications.

In some embodiments, the data object may include an additional sub-object, the first copy of the data object may include a first copy of the additional sub-object, the second copy of the data object may include a second copy of the additional sub-object, and the computer program code may include computer instructions configured to cause the processing device to detect a change to the first copy of the additional sub-object stored in the first data center and update, in response to detecting the change to the first copy of the additional sub-object, the second copy of the additional sub-object stored in the second data center via a communication network to implement the detected change. Additionally, or alternatively, the data object may include data associated with a user, and (i) the additional sub-object may include an address of the user and the change may include an update of the address of the user, (ii) the additional sub-object may include requests made by the user and the change may include a new request for a new checkbook made by the user, (iii) the additional sub-object may include scheduled transactions associated with the user and the change may include a new scheduled future transaction, and/or the like.

In some embodiments, the computer program code may include computer instructions configured to cause the processing device to transmit, in response to detecting the change, instructions via a communication network to the second data center, where the instructions cause the second data center to obtain the updated second copy of the critical sub-object from the quantum network.

In some embodiments, the computer program code may include computer instructions configured to cause the processing device to transmit, in response to detecting the change, instructions via a communication network to the second data center, where the instructions cause the second data center to clear caches including the data object and update the caches to include the updated second copy of the critical sub-object.

In some embodiments, the computer program code may include computer instructions configured to cause the processing device to, when detecting the change to the first copy of the critical sub-object stored in the first data center, detect the change by performing a bell state measurement.

In some embodiments, the computer program code may include computer instructions configured to cause the processing device to, when detecting the change to the first copy of the critical sub-object stored in the first data center, detect a change in a state of the first copy of the critical sub-object by performing a bell state measurement.

In some embodiments, the computer program code may include computer instructions configured to cause the processing device to, when updating the second copy of the critical sub-object stored in the second data center, control a clock speed in the quantum network such that a state of the second copy of the critical sub-object matches the state of the first copy of the critical sub-object.

In some embodiments, the data object may include data associated with a user, the critical sub-object may include a balance of an account associated with the user, and the change to the first copy of the critical sub-object may include the user conducting a transaction that alters the balance of the account.

In some embodiments, the data object may include data associated with a user, the critical sub-object may include a balance of an account associated with the user, and the change to the first copy of the critical sub-object may include processing of a transaction that alters the balance of the account.

In another aspect, the present invention is directed to a computer program product for managing states of data objects using entanglement in a quantum network. The computer program product may include a non-transitory computer-readable medium including code causing an apparatus to identify, for a data object including sub-objects, a critical sub-object of the data object, where a first data center stores a first copy of the data object including a first copy of the critical sub-object, and where a second data center stores a second copy of the data object including a second copy of the critical sub-object. The computer program product may include a non-transitory computer-readable medium including code causing an apparatus to entangle, using a first network interface and in response to identifying the critical sub-object, the first copy of the critical sub-object and the second copy of the critical sub-object on a quantum network, where the first network interface is configured to communicate via the quantum network. The computer program product may include a non-transitory computer-readable medium including code causing an apparatus to detect, using a second network interface, a change to the first copy of the critical sub-object stored in the first data center, where the second network interface is configured to communicate via a communication network. The computer program product may include a non-transitory computer-readable medium including code causing an apparatus to update, using the first network interface and in response to detecting the change, the second copy of the critical sub-object stored in the second data center via the quantum network to implement the detected change.

In some embodiments, the non-transitory computer-readable medium may include code causing the apparatus to identify additional critical sub-objects of a plurality of objects having copies stored on a plurality of data centers including the first data center and the second data center.

In some embodiments, the first data center may provide access to data objects for applications executed by a first plurality of devices located in a first geographical region, and the second data center may provide access to the data objects for the applications executed by a second plurality of devices located in a second geographical region that is different from the first geographical region.

In some embodiments, the first data center may provide access to data objects for applications executed by a first plurality of devices of a first type, and the second data center may provide access to the data objects for the applications executed by a second plurality of devices of a second type that is different from the first type.

In some embodiments, the first data center may provide access to data objects for first applications, and the second data center may provide access to the data objects for second applications that are different from the first applications.

In another aspect, the present invention is directed to a method for managing states of data objects using entanglement in a quantum network. The method may include identifying, for a data object including sub-objects, a critical sub-object of the data object, where a first data center stores a first copy of the data object including a first copy of the critical sub-object, and where a second data center stores a second copy of the data object including a second copy of the critical sub-object. The method may include entangling, using a first network interface and in response to identifying the critical sub-object, the first copy of the critical sub-object and the second copy of the critical sub-object on a quantum network, where the first network interface is configured to communicate via the quantum network. The method may include detecting, using a second network interface, a change to the first copy of the critical sub-object stored in the first data center, where the second network interface is configured to communicate via a communication network. The method may include updating, using the first network interface and in response to detecting the change, the second copy of the critical sub-object stored in the second data center via the quantum network to implement the detected change.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components or blocks than those shown in the figures.

FIGS. 1A-1D illustrate technical components of an exemplary distributed computing environment for managing states of data objects using entanglement in a quantum network, in accordance with an embodiment of the disclosure;

FIG. 2 illustrates a process flow for managing states of data objects using entanglement in a quantum network, in accordance with an embodiment of the disclosure.

FIG. 3 illustrates another process flow for managing states of data objects using entanglement in a quantum network, in accordance with an embodiment of the disclosure.

FIG. 4 illustrates another process flow for managing states of data objects using entanglement in a quantum network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transaction, activities, or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer,” a “transaction,” a “transaction event,” or a “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

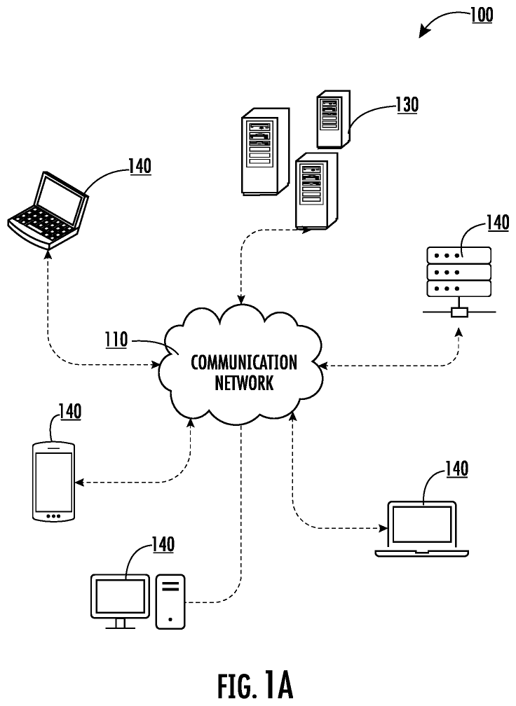

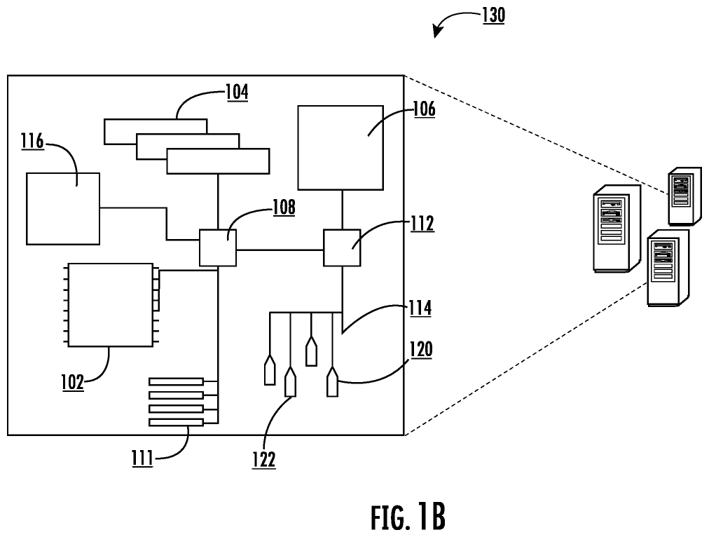

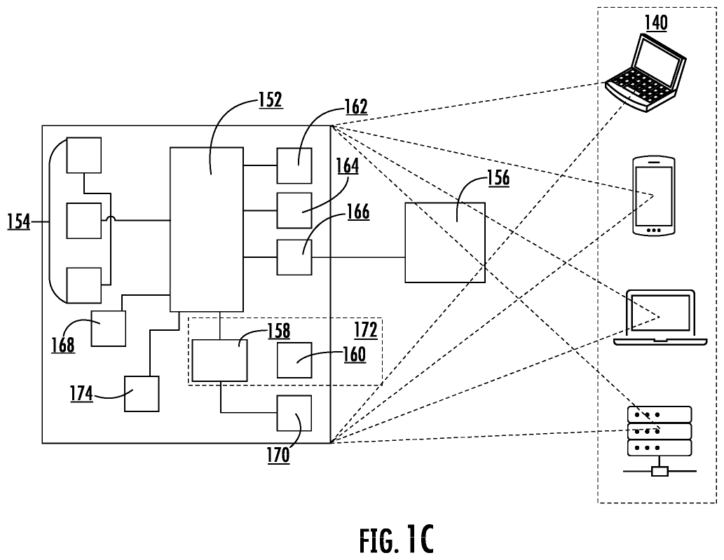

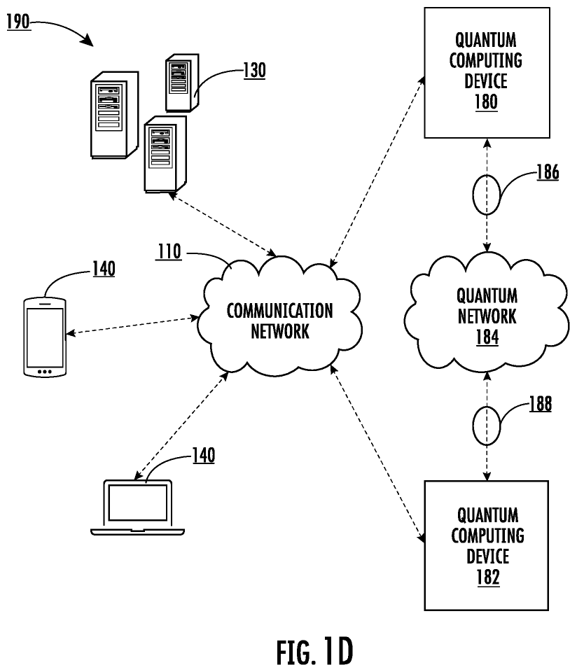

FIGS. 1A-1D illustrate technical components of an exemplary distributed computing environment 100 for managing states of data objects using entanglement in a quantum network, in accordance with an embodiment of the disclosure. As shown in FIG. 1A, the distributed computing environment 100 contemplated herein may include a system 130, an end-point device(s) 140, and a communication network 110 over which the system 130 and end-point device(s) 140 communicate therebetween. FIG. 1A illustrates only one example of an embodiment of the distributed computing environment 100, and in some embodiments one or more of the systems, devices, and/or servers may be combined into a single system, device, and/or server, and/or be made up of multiple systems, devices, and/or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., the system 130). In some other embodiments, the system 130 and the end-point device(s) 140 may have a peer-to-peer relationship in which the system 130 and the end-point device(s) 140 are considered equal and all have the same abilities to use the resources available on the communication network 110. Instead of having a central server (e.g., system 130) which would act as the shared drive, each device that is connect to the communication network 110 would act as the server for the files stored on it.

The system 130 may represent various forms of servers, such as web servers, database servers, file servers, and/or the like, various forms of digital computing devices, such as laptops, desktops, video recorders, audio/video players, radios, workstations, and/or the like, and/or any other auxiliary network devices, such as wearable devices, Internet-of-things devices, electronic kiosk devices, entertainment consoles, mainframes, and/or the like, and/or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The communication network 110 may be a distributed network that is spread over different networks. This provides a single data communication network, which can be managed jointly or separately by each network. Besides shared communication within the network, the distributed network often also supports distributed processing. The communication network 110 may be a form of digital communication network such as a telecommunication network, a local area network (“LAN”), a wide area network (“WAN”), a global area network (“GAN”), the Internet, and/or the like. The communication network 110 may be secure and/or unsecure and may also include wireless and/or wired and/or optical interconnection technology.

The structure of the distributed computing environment and its components, connections and relationships, and their functions, are exemplary, and are not meant to limit implementations of the disclosures described and/or claimed herein. For example, the distributed computing environment 100 may include more, fewer, and/or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102 (e.g., a processing device), memory 104, a storage device 106, and an input/output (I/O) device 116. The system 130 may also include a high-speed interface 108 connecting to the memory 104, and a low-speed interface 112 connecting to low-speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. For example, the processor 102 may execute computer program code stored on a non-transitory storage device (e.g., the memory 104), which may cause the processor 102 to perform one or more of the process flows described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may include a computer-readable medium, such as a floppy disk device, a hard disk device, an optical disk device, a tape device, a flash memory, or other similar solid state memory device, and/or an array of devices, including devices in a storage area network or other configurations. A computer program product can be tangibly embodied in an information carrier. The computer program product may also contain instructions that, when executed, perform one or more methods, such as those described herein. The information carrier may be a computer-readable medium and/or a machine-readable medium, such as the memory 104, the storage device 106, and/or memory on processor 102.

The high-speed interface 108 manages bandwidth-intensive operations for the system 130, while the low-speed interface 112 (e.g., a low-speed controller) manages lower bandwidth-intensive operations. Such allocation of functions is exemplary. In some embodiments, the high-speed interface 108 is coupled to memory 104, the input/output (I/O) device 116 (e.g., through a graphics processor or accelerator), and high-speed expansion ports 111, which may accept various expansion cards. In some embodiments, the low-speed interface 112 may be coupled to the storage device 106 and the low-speed bus 114 (e.g., a low-speed expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device, such as a switch or router (e.g., through a network adapter). As shown in FIG. 1B, the system 130 may include one network interface 120 configured to communicate via a quantum network (e.g., a network configured to provide communication between devices and/or systems by transmitting and receiving qubits) and another network interface 122 configured to communicate via the communication network 110 (e.g., a network configured to provide communication between devices and/or systems by transmitting and receiving data packets).

The system 130 may be implemented in a number of different forms. For example, the system 130 may be implemented as a standard server, or multiple times in a group of such servers. In some embodiments, the system 130 may also be implemented as part of a rack server system or a personal computer such as a laptop computer. Additionally, or alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152 (e.g., a processing device), memory 154, an input/output device 156 (e.g., a display), a communication interface 158, and a transceiver 160, among other components. The end-point device(s) 140 may also be provided with a storage device, such as a microdrive or other device, to provide additional storage. Each of the components 152, 154, 156, 158, and 160, may be interconnected using various buses, cables, and/or the like and several of the components may be mounted on a common motherboard or in other manners as appropriate.

The processor 152 may be configured to execute instructions within the end-point device(s) 140, including instructions stored in the memory 154, which in one embodiment may include the instructions of an application that may perform the functions disclosed herein, including certain logic, data processing, and data storing functions. For example, the processor 152 may execute computer program code stored on a non-transitory storage device (e.g., the memory 154), which may cause the processor 152 to perform one or more of the process flows described herein. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and/or wireless communication by end-point device(s) 140.

The processor 152 may be configured to communicate with the user through a control interface 164 and a display interface 166 coupled to the input/output device 156. The input/output device 156 may be, for example, a TFT LCD (Thin-Film-Transistor Liquid Crystal Display) or an OLED (Organic Light Emitting Diode) display, or other appropriate display technology. The display interface 166 may include appropriate circuitry and be configured for driving the input/output device 156 to present graphical and other information to a user. The control interface 164 may receive commands from a user and convert them for submission to the processor 152. In addition, an external interface 168 may be provided in communication with the processor 152, so as to enable near area communication of end-point device(s) 140 with other devices. External interface 168 may provide, for example, for wired communication and/or wireless communication, and the end-point device(s) 140 may include multiple external interfaces 168. In some embodiments, the control interface 164 and/or the display interface 166 may include a heads-up display worn on the user's head, one or more devices worn by the user (e.g., on the user's hands), one or more devices held by the user (e.g., a controller device), and/or the like for rendering visual content, receiving input from the user, providing haptic feedback to the user, and/or the like. For example, the end-point device(s) 140 may be and/or include a virtual reality headset, a virtual reality system (e.g., including a headset and one or more accessories), and/or the like.

The memory 154 stores information within the end-point device(s) 140. The memory 154 may be implemented as one or more of a computer-readable medium or media, a volatile memory unit or units, and/or a non-volatile memory unit or units. Expansion memory may also be provided and connected to end-point device(s) 140 through an expansion interface, which may include, for example, a SIMM (Single In Line Memory Module) card interface. Such expansion memory may provide extra storage space for end-point device(s) 140 and may also store applications and/or other information therein. In some embodiments, expansion memory may include instructions to carry out or supplement the processes described herein and may include secure information. For example, expansion memory may be provided as a security module for end-point device(s) 140 and may be programmed with instructions that permit secure use of end-point device(s) 140. Additionally, or alternatively, secure applications may be provided via SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product may include instructions that, when executed, perform one or more methods, such as those described herein. The information carrier may be a computer-readable medium and/or a machine-readable medium, such as the memory 154, expansion memory, memory on the processor 152, and/or a propagated signal that may be received, for example, over transceiver 160 and/or external interface 168.

In some embodiments, a user may use the end-point device(s) 140 to transmit and/or receive information and/or commands to and/or from the system 130 via the communication network 110. Communication between the system 130 and the end-point device(s) 140 may be subject to an authentication protocol allowing the system 130 to maintain security by permitting only authenticated users and/or processes to access protected resources of the system 130, which may include servers, databases, applications, and/or any of the components described herein. To this end, the system 130 may trigger an authentication subsystem that may require the user and/or the process to provide authentication credentials to determine whether the user and/or the process is eligible to access the protected resources. Once the authentication credentials are validated and the user and/or the process is authenticated, the authentication subsystem may provide the user and/or the process with permissioned access to the protected resources. Similarly, the end-point device(s) 140 may provide the system 130 and/or other client devices permissioned access to the protected resources of the end-point device(s) 140, which may include a GPS (Global Positioning System) device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes and/or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. The communication interface 158 may provide for communications under various telecommunications standards (e.g., 2G, 3G, 4G, 5G, and/or the like) using their respective layered protocol stacks. These communications may occur through a transceiver 160, such as a radio-frequency transceiver. Short-range communication may occur, such as using a Bluetooth, Wi-Fi, or other such transceiver. In some embodiments, the communication interface 158 and the transceiver 160 may form a network interface 172 configured to communicate via the communication network 110 (e.g., a network configured to provide communication between devices and/or systems by transmitting and receiving data packets). GPS receiver module 170 may provide additional navigation-related and/or location-related wireless data to end-point device(s) 140, which may be used as appropriate by applications running thereon, and in some embodiments, one or more applications operating on the system 130. The end-point device(s) 140 may also include another network interface 174 configured to communicate via a quantum network (e.g., a network configured to provide communication between devices and/or systems by transmitting and receiving qubits).

The end-point device(s) 140 may also communicate audibly using audio codec 162, which may receive spoken information from a user and convert the spoken information to usable digital information. Audio codec 162 may likewise generate audible sound for a user, such as through a speaker (e.g., in a handset) of end-point device(s) 140. Such sound may include sound from voice telephone calls, may include recorded sound (e.g., voice messages, music files, and/or the like), and/or may include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

FIG. 1D illustrates another exemplary distributed computing environment 190 for managing states of data objects using entanglement in a quantum network, in accordance with an embodiment of the disclosure. As shown in FIG. 1D, the distributed computing environment 190 contemplated herein may include the system 130, the end-point device(s) 140, and the communication network 110 over which the system 130 and end-point device(s) 140 communicate therebetween. As also shown in FIG. 1D, the distributed computing environment 190 may include a quantum computing device 180, a quantum computing device 182 and a quantum network 184 over which the quantum computing device 180 and the quantum computing device 182 communicate therebetween by transmitting and receiving qubits 186 and 188. Furthermore, the quantum computing device 180 and the quantum computing device 182 may also communicate over the communication network 110 with the system 130, the end-point device(s) 140, and each other using data packets, as shown in FIG. 1D. As will be appreciated by one of ordinary skill in the art in view of the present disclosure, embodiments of the exemplary distributed computing environment 190 may include more systems, end-point devices, quantum computing devices, communication networks, quantum networks, and/or the like than those shown in FIG. 1D.

In some embodiments, the quantum computing device 180 and the quantum computing device 182 may be in signal communication with each other using the quantum network 184. The quantum network 184 may be configured to facilitate the transmission of information using qubits (e.g., the qubits 186 and 188 as shown in FIG. 1D). The quantum network 184 may include optical fibers, optical switches, repeaters, and/or any suitable type of hardware and communication channels for transmitting and receiving qubits.

In some embodiments, the quantum computing device 180 and/or the quantum computing device 182 may each include a quantum processing unit (QPU), a qubit signal amplifier, input microwave lines, superconducting coaxial lines, a mixing chamber, cryogenic isolators, quantum amplifiers, a cryoperm shield, quantum logical gates, and/or any other suitable components for generating and/or processing qubits. The quantum computing device 180 and/or the quantum computing device 182 may be configured to generate qubits, to encode data using qubits based on a set of encoding instructions, and to transmit qubits over the quantum network 184. The quantum computing device 180 and/or the quantum computing device 182 may also be configured to receive qubits and to convert the qubits into binary bit values to recover the encoded data. In some embodiments, the quantum computing device 180 and/or the quantum computing device 182 may be integrated with and/or configured to work cooperatively with a traditional computing device such as a desktop computer or a laptop. Furthermore, the quantum computing device 180 and/or the quantum computing device 182 may include one or more components of the system 130 and/or the end-point device(s) 140 as described herein with respect to FIGS. 1A-1C.

In some embodiments, the quantum computing device 180 and/or the quantum computing device 182 may include any computer that utilizes the principles of quantum physics to perform computational operations. The quantum computing device 180 and/or the quantum computing device 182 may implement variations of quantum computer design, such as photonic quantum computing, superconducting quantum computing, nuclear magnetic resonance quantum computing, ion-trap quantum computing, and/or the like. Regardless of the particular type of quantum computer implementation, the quantum computing device 180 and/or the quantum computing device 182 may encode data onto qubits. Whereas classical computers encode bits into ones and zeros, the quantum computing device 180 and/or the quantum computing device 182 may encode data by placing a qubit into one of two identifiable quantum states. Unlike conventional bits, however, qubits may exhibit quantum behavior, allowing the quantum computer to process a vast number of calculations simultaneously. Similarly, data may be communicated using qubits and the quantum properties of light, such as by laser or over fiber optic networks.

A qubit may be formed by any two-state quantum mechanical system. For example, in some embodiments, a qubit may be the polarization of a single photon and/or the spin of an electron. Qubits may be subject to quantum phenomena that cause them to behave much differently than classical bits. Quantum phenomena may include superposition, entanglement, tunneling, superconductivity, and/or the like.

Two quantum phenomena may be employed when data is communicated based on quantum properties or in a quantum computer: superposition and entanglement. Superposition may refer to the ability of a quantum particle to be in multiple states at the same time. Entanglement may refer to the correlation between two quantum particles that forces the particles to behave in the same way even if they are separated by great distances. Together, these two principles may allow the quantum computing device 180 and/or the quantum computing device 182 to process a vast number of calculations simultaneously. Further, these two principles each individually may form the basis for various types and theories of quantum data transmission. For example, two copies of a data object and/or a sub-object of a data object may each be represented by a quantum particle on two different quantum computing devices and the two copies may be entangled such that there is a correlation between the two quantum particles that forces the particles to behave in the same way even if they are separated by great distances.

In a quantum computer (e.g., such as the quantum computing device 180 and/or the quantum computing device 182) with n qubits, the quantum computer may be in a superposition of up to 2n states simultaneously. By comparison, a classical computer can only be in one of the 2n states at a single time. As such, a quantum computer can perform vastly more calculations in a given time period than its classical counterpart. For example, a quantum computer (e.g., the quantum computing device 180 and/or the quantum computing device 182) with two qubits can store the information of four classical bits. This is because the two qubits will be a superposition of all four possible combinations of two classical bits (00, 01, 10, or 11). Similarly, a three-qubit system can store the information of eight classical bits, four qubits can store the information of sixteen classical bits, and so on. A quantum computer with three hundred qubits could possess the processing power equivalent to the number of atoms in the known universe.

In some embodiments, the distributed computing environment 190 may be configured to use entangled qubits. When a qubit is in an entangled state, the qubit may be a mixture of values. The actual value of the entangled qubit may be unknown until a measurement is made on the entangled qubit to determine the value of the qubit. However, measuring the value of a qubit is a destructive process which means that the qubit is no longer available after the measurement is made. Using entangled qubits to encode and transmit information may provide improved information security since the value of the qubits is unknown during transmission. In addition, a bad actor is unable to intercept the qubits and to determine the values of the qubits without destroying the qubits. Furthermore, by storing one copy of a data object on the quantum computing device 180 that is entangled with another copy of the data object stored on the quantum computing device 182, after a bell state measurement determines that the copy on the quantum computing device 180 has changed states (e.g., due to a change in the data object and/or a sub-object of the data object), the other copy of the data object stored on the quantum computing device 182 may be updated in real-time to replicate the change to the data object. Thus, the distributed computing environment 190 may use the quantum network 184 to maintain identical copies of a data object that are updated in real-time for access by disparately located systems and/or end-point devices (e.g., such as the system 130 and/or the end-point device(s) 140).

As noted, in order to maintain consistency in application outputs through various channel applications, data consistency and timely availability should be maintained across data centers/clusters/zones. Various techniques may be employed in an effort to ensure that data updated in one data center/cluster/zone is replicated in other data centers/clusters/zones. However, various technological issues may still impact the replication process, such as network data transfer issues, slow bandwidth resulting in delays in replication, missed packets resulting in several critical issues, and/or the like. To avoid such issues, periodic eventual consistency may be employed, but such a technique takes time to reflect changes (e.g., delayed and inconsistent data exist until updates are replicated completely with multiple tries) and depends on similar data transmission methods that lead to failure at times resulting in a similar periodic cycle.

Such issues may be caused because data packets of data objects are maintained in different states at each data center/cluster/zone. For example, different copies in different data centers/clusters/zones that are intended to remain identical by copying and/or replicating. When the data packets are updated, the updated data packets are intended to be moved from one data center/cluster/zone, thereby causing the above-noted issues.

In view of the foregoing, the present invention is directed to a system for managing states of data objects in some embodiments. The system may be configured to ensure that different copies of critical data (e.g., financial data) remain in a single state even though the critical data is available and is being updated from multiple data centers/clusters/zones. In some embodiments, the system may be configured to maintain the single state without moving and/or replicating data across data centers/clusters/zones. For example, as soon as a data packet in one data center/cluster/zone is changed, the data packet in another data center/cluster/zone breaks into the same state. In some embodiments, the system may allow multiple copies available at multiple data centers/clusters/zones to maintain availability and permit faster data reads, while ensuring the copies remain tied to each other without data loss due to replication issues.

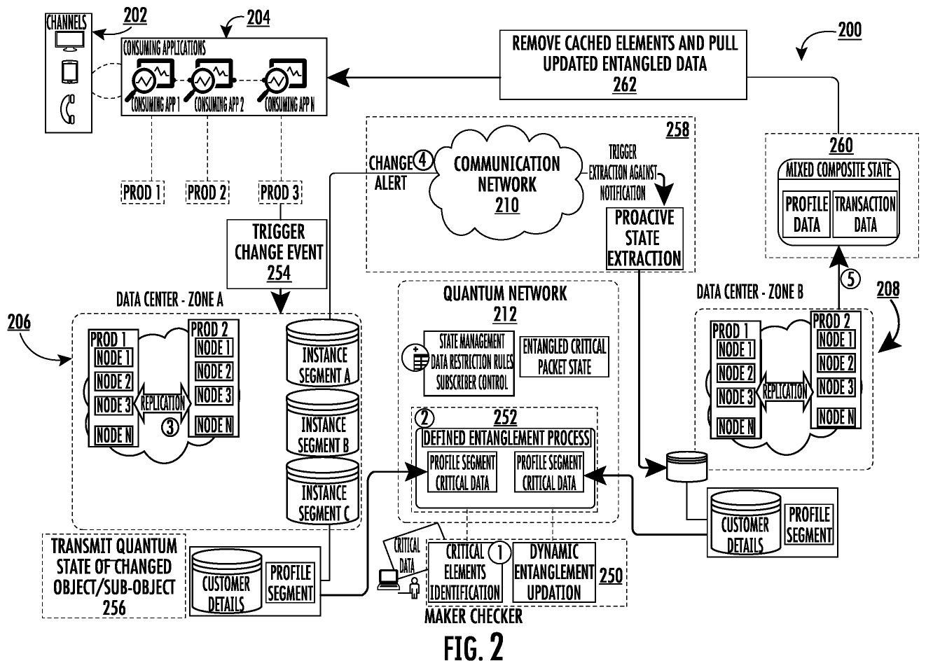

FIG. 2 illustrates a process flow 200 for managing states of data objects using entanglement in a quantum network, in accordance with an embodiment of the disclosure. In some embodiments, the process flow 200 may be a software-controlled defined dynamic entanglement for resilient state management for data across data centers/clusters/zones including a custom entanglement process leading to state overlaps triggered by bell state measurements and applied via controlled clock speeds.

As shown in FIG. 2, the process flow 200 may include a plurality of channels for obtaining data (e.g., computers, mobile devices, smartphones, voice-based communications, and/or the like) that run one or more consuming applications 204. The consuming applications 204 may obtain data objects from Zone A data center 206 and/or Zone B data center 208 (e.g., based on geographical location, device type, application, and/or the like), where the data objects in the Zone A data center 206 correspond to the data objects in the Zone B data center 208. In some embodiments, the systems and/or devices executing the consuming applications 204 may be similar to the system 130 and/or the end-point device(s) 140 shown and described herein with respect to Figures IA-ID. Additionally, or alternatively, the Zone A data center 206 and/or Zone B data center 208 may include and/or be similar to the system 130 and/or the end-point device(s) 140 shown and described herein with respect to FIGS. 1A-1D.

As also shown in FIG. 2, the process flow 200 may include a communication network 210 and a quantum network 212. In some embodiments, the communication network 210 may be similar to the communication network 110 shown and described herein with respect to FIGS. 1A-1D. Additionally, or alternatively, the quantum network 212 may be similar to the quantum network 184 shown and described herein with respect to FIG. 1D, and may include one or more quantum computing devices similar to the quantum computing device 180 and/or the quantum computing device 182 shown and described herein with respect to FIG. 1D.

As shown in FIG. 2, the process flow 200 may include a step 250 of identifying a critical sub-object under a parent object and tagging the critical sub-object for dynamic entanglement, such that real-time changes to the sub-object lead to re-entanglement. The sub-object may be controlled and configurable. In some embodiments, and as shown in FIG. 2, the process flow 200 may include a user supervising, reviewing, confirming, and/or the like the identification and/or tagging of one or more sub-objects as critical.

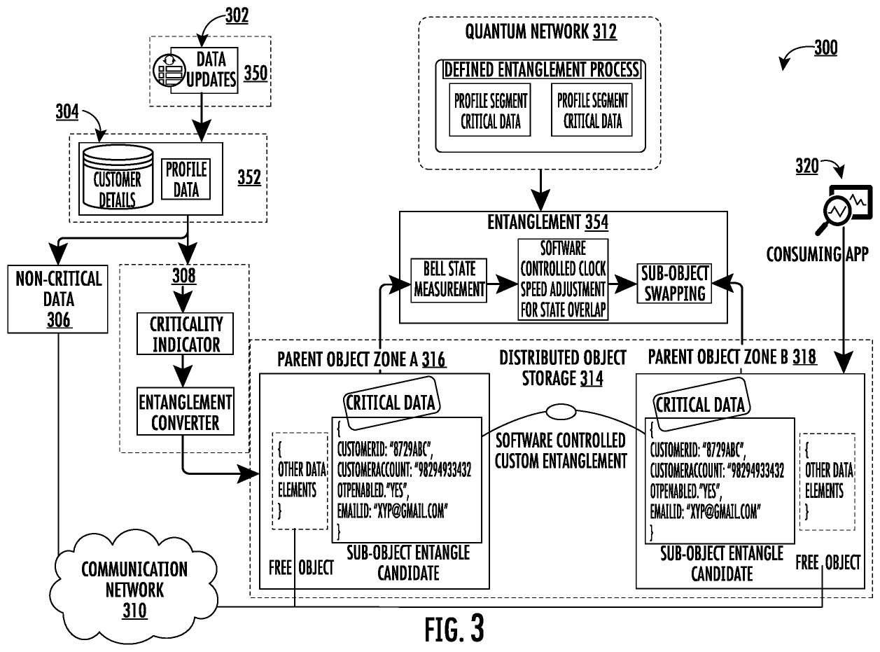

As shown in FIG. 2, the process flow 200 may include a step 252 of entangling the identified/tagged critical sub-objects. For example, and as shown in FIG. 2, the process flow 200 may include entangling, within the quantum network 212, a tagged critical sub-object in the Zone A data center 206 with a corresponding critical sub-object in the Zone B data center 208. Further details regarding such a software-controlled custom entanglement are described herein with respect to FIG. 3.

As shown in FIG. 2, the process flow 200 may include a step 254 of triggering a change event, which generates an alert transmitted via the communication network 210. For example, and as shown in FIG. 2, the process flow 200 may include one of the consuming applications 204 changing a critical data object and/or a critical sub-object in the Zone A data center 206, and the Zone A data center 206 transmitting, in response to the change, an alert via the communication network 210.

As shown in FIG. 2, the process flow 200 may include a step 256 of capturing and transmitting a quantum state of the changed critical data object and/or the changed critical sub-object via the quantum network 212. For example, the quantum state may be transmitted via the quantum network 212 due to the entangling of the identified/tagged critical sub-objects performed during step 252 of the process flow 200.

As shown in FIG. 2, the process flow 200 may include a step 258 of triggering a proactive state extraction (e.g., in response to the alert transmitted via the communication network 210). For example, and as shown in FIG. 2, the Zone B data center 208 may be triggered to update and/or change the critical data object and/or the critical sub-object stored in the Zone B data center 208 based on the changed quantum state of the critical data object and/or the critical sub-object in the quantum network 212.

As shown in FIG. 2, the process flow 200 may include a step 260 of providing the composite state of the critical data object and/or the critical sub-object as available from the Zone B data center 208. For example, the Zone B data center 208 may store a parent object for the data object, and may provide the parent object as available for the consuming applications 204 with the parent object reflecting the updated and/or changed state of the critical data object and/or the critical sub-object.

As shown in FIG. 2, the process flow 200 may include a step 262 of removing cached elements and pulling updated entangled data. For example, the Zone B data center 208 may provide and/or populate one or more caches for the consuming applications 204, and the process flow 200 may include removing elements from and/or clearing the caches and populating the caches with the updated and/or changed critical data object and/or critical sub-object.

In some embodiments, one or more systems for managing states of data objects using entanglement in a quantum network (e.g., similar to the system 130 described herein with respect to FIGS. 1A-1C, similar to the end-point device(s) 140 described herein with respect to FIGS. 1A-1C, and/or the like) may perform the process flow 200. As will be appreciated by one of ordinary skill in the art in view of the present disclosure, the process flow 200 may include additional steps, alternative steps, and/or the like. The process flow 200 may include additional embodiments, such as any single embodiment or any combination of embodiments described herein. Although FIG. 2 shows example blocks of the process flow 200, in some embodiments, the process flow 200 may include additional blocks, fewer blocks, different blocks, or differently arranged blocks than those depicted in FIG. 2. Additionally, or alternatively, two or more of the blocks of the process flow 200 may be performed in parallel.

FIG. 3 illustrates another process flow 300 for managing states of data objects using entanglement in a quantum network, in accordance with an embodiment of the disclosure. In some embodiments, one or more of the steps of the process flow 300 may be performed in conjunction with the process flow 200 shown and described herein with respect to FIG. 2. For example, one or more of the steps of the process flow 300 may be sub-steps of one or more of the steps of the process flow 200.

As shown in FIG. 2, the process flow 300 may include data updates 302 to a database 304 including customer data, account data, and/or the like, non-critical data 306, critical data 308, a communication network 310, a quantum network 312, a distributed object storage 314 including parent object zone A 316 and parent object zone B 318, and consuming applications 320. In some embodiments, the systems and/or devices performing the data updates and/or executing the consuming applications 320 may be similar to the system 130 and/or the end-point device(s) 140 shown and described herein with respect to FIGS. 1A-1D.

In some embodiments, the parent object zone A 316 may correspond to a parent object stored for a data center similar to the Zone A data center 206 as shown and described herein with respect to FIG. 2. Additionally, or alternatively, the parent object zone B 318 may correspond to a parent object stored for a data center similar to the Zone B data center 208 as shown and described herein with respect to FIG. 2. In this regard, the parent object zone A 316 may correspond to the parent object zone B 318.

In some embodiments, the communication network 310 may be similar to the communication network 110 and/or the communication network 210 shown and described herein with respect to FIGS. 1A-1D and 2, respectively. Additionally, or alternatively, the quantum network 312 may be similar to the quantum network 184 shown and described herein with respect to FIG. 1D, and may include one or more quantum computing devices similar to the quantum computing device 180 and/or the quantum computing device 182 shown and described herein with respect to FIG. 1D. In some embodiments, the quantum network 312 may be similar to the quantum network 212 shown and described herein with respect to FIG. 2.

In some embodiments, the distributed object storage 314 may be similar to the system 130 and/or the end-point device(s) 140 shown and described herein with respect to FIGS. 1A-1D, the quantum computing device 180 and/or the quantum computing device 182 shown and described herein with respect to FIG. 1D, and/or the quantum network 184 shown and described herein with respect to FIG. 1D. For example, the quantum network 312 may include one or more quantum computing devices similar to the quantum computing device 180 and/or the quantum computing device 182 shown and described herein with respect to FIG. 1D, and the quantum computing devices of the quantum network 312 may provide the distributed object storage 314.

As shown in FIG. 3, the process flow 300 may include a step 350 of receiving the data updates 302 at the database 304. For example, one or more systems and/or devices (e.g., executing the consuming applications 320) may perform the data updates 302 to one or more data objects stored in the database 304 of a Zone A data center.

As shown in FIG. 3, the process flow 300 may include a step 352 of determining, for each of the data updates 302, whether the data update is an update to non-critical data 306 or an update to critical data 308. For example, the process flow 300 may include determining whether a given data update is changing non-critical data (e.g., an update of an address of a user, a new request for a new checkbook made by a user, a new scheduled future transaction, and/or the like). In this regard, non-critical data may refer to data that does not need to be updated in real-time across data centers/clusters/zones to maintain system functionality and/or integrity (e.g., for the consuming applications 320). As shown in FIG. 3, the process flow 300 may include updating the parent object zone A 316 and the parent object zone B 318 via the communication network 310 in response to determining that a given data update is changing non-critical data 306.

As another example, the process flow 300 may include determining whether a given data update is changing critical data (e.g., a user conducting a transaction that alters a balance of an account, processing of a transaction that alters a balance of an account, and/or the like). In this regard, critical data may refer to data that does need to be updated in real-time across data centers/clusters/zones to maintain system functionality and/or integrity (e.g., for the consuming applications 320).

In some embodiments, and as shown in FIG. 3, the process flow 300 may include identifying a criticality indicator (e.g., a tag) in the critical data 308 (e.g., provided during step 250 of the process flow 200 as described herein with respect to FIG. 2) and providing the critical data 308 to an entanglement converter. In some embodiments, the process flow 300 may include using the entanglement converter to trigger state management functions as soon as criticality indicators identify a change in critical data (e.g., a critical data object, a critical sub-object of a data object, and/or the like).

As shown in FIG. 3, the process flow 300 may include updating the parent object zone A 316 in response to determining that that a given data update is changing critical data 308. For example, the critical data 308 in the parent object zone A 316 may be updated to reflect the data update.

As shown in FIG. 3, the process flow 300 may include a step 354 of performing entanglement in the quantum network 312. For example, and as shown in FIG. 3, the process flow 300 may include (e.g., in response to receiving a change notification to critical data in the parent object zone A 316 via the communication network 310 and/or the quantum network 312) performing a bell state measurement to verify state differences. As also shown in FIG. 3, the process flow 300 may include (e.g., in response to verifying the state differences) performing a software-controlled clock speed adjustment to achieve state overlap and performing sub-object swapping in the parent object zone B 318. Such steps may occur in real-time in response to determining that a given update is changing critical data, such that copies of the changed critical data in different data centers/clusters/zones are correspondingly changed in real-time. As shown in FIG. 3, the consuming applications 320 may then access the updated data in the parent object zone B 318 in the distributed object storage 314 via one or more data centers.

In some embodiments, one or more systems for managing states of data objects using entanglement in a quantum network (e.g., similar to the system 130 described herein with respect to FIGS. 1A-1C, similar to the end-point device(s) 140 described herein with respect to FIGS. 1A-1C, and/or the like) may perform the process flow 300. As will be appreciated by one of ordinary skill in the art in view of the present disclosure, the process flow 300 may include additional steps, alternative steps, and/or the like. The process flow 300 may include additional embodiments, such as any single embodiment or any combination of embodiments described herein. Although FIG. 3 shows example blocks of the process flow 300, in some embodiments, the process flow 300 may include additional blocks, fewer blocks, different blocks, or differently arranged blocks than those depicted in FIG. 3. Additionally, or alternatively, two or more of the blocks of the process flow 300 may be performed in parallel.

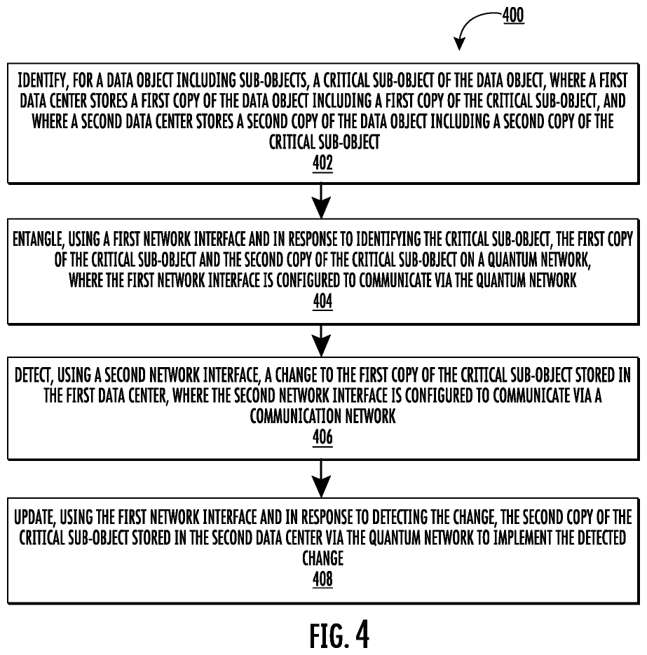

FIG. 4 illustrates another process flow 400 for managing states of data objects using entanglement in a quantum network, in accordance with an embodiment of the disclosure. In some embodiments, one or more systems for managing states of data objects using entanglement in a quantum network (e.g., similar to the system 130 described herein with respect to FIGS. 1A-IC, similar to the end-point device(s) 140 described herein with respect to FIGS. 1A-1C, and/or the like) may perform the process flow 400.

As shown in block 402, the process flow 400 may include identifying, for a data object including sub-objects, a critical sub-object of the data object, where a first data center stores a first copy of the data object including a first copy of the critical sub-object, and where a second data center stores a second copy of the data object including a second copy of the critical sub-object. For example, a system for managing states of data objects may identify, for a data object including sub-objects, a critical sub-object of the data object. In some embodiments, the first data center and the second data center may store corresponding copies of the data object, where each copy of the data object includes a copy of the critical sub-object. Additionally, or alternatively, the process flow 400 may include determining whether a given sub-object of a data object is critical by determining whether the sub-object includes (i) financial data and/or data associated with a conducted transaction or (ii) data associated with a user, data associated with a future transaction, and/or data associated with a user request to be fulfilled at a later time.

In some embodiments, the process flow 400 may include identifying additional critical sub-objects of a plurality of objects having copies stored on a plurality of data centers including the first data center and the second data center. For example, an entity may have a plurality of data centers (e.g., in a plurality of geographical locations to provide access to data objects for applications executing on devices in a plurality of geographical regions), and the process flow 400 may include identifying critical objects and/or sub-objects in the data centers. In such an example, the critical objects and/or sub-objects may be identified when the critical objects and/or sub-objects are created, stored in the data centers, uploaded to the data centers, and/or the like.

In some embodiments, the first data center may provide access to data objects for applications executed by a first plurality of devices located in a first geographical region, and where the second data center may provide access to the data objects for the applications executed by a second plurality of devices located in a second geographical region that is different from the first geographical region. Additionally, or alternatively, the first data center may provide access to data objects for applications executed by a first plurality of devices of a first type, and the second data center may provide access to the data objects for the applications executed by a second plurality of devices of a second type that is different from the first type. In some embodiments, the first data center may provide access to data objects for first applications, and the second data center may provide access to the data objects for second applications that are different from the first applications.

As shown in block 404, the process flow 400 may include entangling, using a first network interface and in response to identifying the critical sub-object, the first copy of the critical sub-object and the second copy of the critical sub-object on a quantum network, where the first network interface is configured to communicate via the quantum network. For example, the process flow 400 may include entangling the first copy of the critical sub-object and the second copy of the critical sub-object in a manner similar to that described herein with respect to FIG. 1D, the process flow 200 of FIG. 2, and/or the process flow 300 of FIG. 3.

As shown in block 406, the process flow 400 may including detecting, using a second network interface, a change to the first copy of the critical sub-object stored in the first data center, where the second network interface is configured to communicate via a communication network. For example, the first data center may generate an alert regarding the change to the first copy of the critical sub-object and transmit the alert via the communication network, and the process flow 400 may include detecting the alert. As another example, the process flow 400 may include monitoring communications between the first data center and consuming applications to detect a change to the first copy of the critical sub-object made by one or more of the consuming applications. As another example, the process flow 400 may include monitoring change requests made by consuming applications to the first data center via the communication network to detect a change to the first copy of the critical sub-object. As another example, the process flow 400 may include monitoring data objects stored in the first data center to detect a change to the first copy of the critical sub-object.

In some embodiments, the data object may include data associated with a user, the critical sub-object may include a balance of an account associated with the user, and the change to the first copy of the critical sub-object may include the user conducting a transaction that alters the balance of the account. Additionally, or alternatively, the data object may include data associated with a user, the critical sub-object may include a balance of an account associated with the user, and the change to the first copy of the critical sub-object may include processing of a transaction that alters the balance of the account.

In some embodiments, the process flow 400 may include performing a bell state measurement on a parent object and/or sub-object representative of the first copy of the data object including the first copy of the sub-object, where the parent object is stored in a distributed object store of the quantum network, to detect a change to the first copy of the critical sub-object. For example, a parent object and/or sub-object corresponding to the first copy of the data object including the first copy of the sub-object may be stored in a distributed object store of the quantum network, and the process flow 400 may include performing a bell state measurement on the parent object and/or sub-object to detect the change. Additionally, or alternatively, the process flow 400 may include, when detecting the change to the first copy of the critical sub-object stored in the first data center, detecting a change in a state of the first copy of the critical sub-object by performing a bell state measurement.

As shown in block 408, the process flow 400 may include updating, using the first network interface and in response to detecting the change, the second copy of the critical sub-object stored in the second data center via the quantum network to implement the detected change. For example, the process flow 400 may include updating the second copy of the critical sub-object stored in the second data center by adjusting a clock speed to achieve a state overlap between a parent object and/or sub-object representative of the second copy of the data object including the second copy of the sub-object, where the parent object is stored in a distributed object store of the quantum network. In some embodiments, the process flow 400 may include, after adjusting the clock speed to achieve the state overlap, replacing the second copy of the sub-object with a copy of the sub-object from the distributed object store of the quantum network. Additionally, or alternatively, the process flow 400 may include, when updating the second copy of the critical sub-object stored in the second data center, controlling a clock speed in the quantum network such that a state of the second copy of the critical sub-object matches the state of the first copy of the critical sub-object.

In some embodiments, the data object may include an additional sub-object, where the first copy of the data object includes a first copy of the additional sub-object, and the second copy of the data object includes a second copy of the additional sub-object. In such embodiments, the process flow 400 may include detecting a change to the first copy of the additional sub-object stored in the first data center and updating, in response to detecting the change to the first copy of the additional sub-object, the second copy of the additional sub-object stored in the second data center via a communication network to implement the detected change. For example, the data object may include data associated with the user, the additional sub-object may include an address of the user, and the change may include an update of the address of the user. As another example, the data object may include data associated with the user, the additional sub-object may include requests made by the user, and the change may include a new request for a new checkbook made by the user. As yet another example, the data object may include data associated with the user, the additional sub-object may include scheduled transactions associated with the user, and the change may include a new scheduled future transaction.

In some embodiments, the process flow 400 may include transmitting, in response to detecting the change, instructions via a communication network to the second data center, where the instructions cause the second data center to obtain the updated second copy of the critical sub-object from the quantum network. Additionally, or alternatively, the process flow 400 may include transmitting, in response to detecting the change, instructions via a communication network to the second data center, where the instructions cause the second data center to clear caches including the data object and update the caches to include the updated second copy of the critical sub-object.

As will be appreciated by one of ordinary skill in the art in view of the present disclosure, the process flow 400 may include additional steps, alternative steps, and/or the like. The process flow 400 may include additional embodiments, such as any single embodiment or any combination of embodiments described herein. Although FIG. 4 shows example blocks of the process flow 400, in some embodiments, the process flow 400 may include additional blocks, fewer blocks, different blocks, or differently arranged blocks than those depicted in FIG. 4. Additionally, or alternatively, two or more of the blocks of the process flow 400 may be performed in parallel.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (e.g., a non-transitory computer readable medium including firmware, resident software, micro-code, computer program code, and/or the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for managing states of data objects using entanglement in a quantum network, the system comprising:
a first network interface configured to communicate via a quantum network;
a second network interface configured to communicate via a communication network;
a non-transitory storage device comprising computer program code stored thereon; and
a processing device operably coupled to the first network interface, the second network interface, and the non-transitory storage device, wherein the computer program code comprises computer instructions configured to cause the processing device to:
identify, for a data object comprising sub-objects, a critical sub-object of the data object, wherein a first data center stores a first copy of the data object comprising a first copy of the critical sub-object, and wherein a second data center stores a second copy of the data object comprising a second copy of the critical sub-object;
entangle, using the first network interface and in response to identifying the critical sub-object, the first copy of the critical sub-object and the second copy of the critical sub-object on the quantum network;
detect, using the second network interface, a change to the first copy of the critical sub-object stored in the first data center; and
update, using the first network interface and in response to detecting the change, the second copy of the critical sub-object stored in the second data center via the quantum network to implement the detected change.

2. The system of claim 1, wherein the computer program code comprises computer instructions configured to cause the processing device to identify additional critical sub-objects of a plurality of objects having copies stored on a plurality of data centers comprising the first data center and the second data center.

3. The system of claim 1, wherein the first data center provides access to data objects for applications executed by a first plurality of devices located in a first geographical region, and wherein the second data center provides access to the data objects for the applications executed by a second plurality of devices located in a second geographical region that is different from the first geographical region.

4. The system of claim 1, wherein the first data center provides access to data objects for applications executed by a first plurality of devices of a first type, and wherein the second data center provides access to the data objects for the applications executed by a second plurality of devices of a second type that is different from the first type.

5. The system of claim 1, wherein the first data center provides access to data objects for first applications, and wherein the second data center provides access to the data objects for second applications that are different from the first applications.

6. The system of claim 1, wherein the data object comprises an additional sub-object, wherein the first copy of the data object comprises a first copy of the additional sub-object, wherein the second copy of the data object comprises a second copy of the additional sub-object, and wherein the computer program code comprises computer instructions configured to cause the processing device to:
detect a change to the first copy of the additional sub-object stored in the first data center; and
update, in response to detecting the change to the first copy of the additional sub-object, the second copy of the additional sub-object stored in the second data center via the communication network to implement the detected change.

7. The system of claim 6, wherein the data object comprises data associated with a user, and wherein:
the additional sub-object comprises an address of the user and the change comprises an update of the address of the user;
the additional sub-object comprises requests made by the user and the change comprises a new request for a new checkbook made by the user; or
the additional sub-object comprises scheduled transactions associated with the user and the change comprises a new scheduled future transaction.

8. The system of claim 1, wherein the computer program code comprises computer instructions configured to cause the processing device to transmit, in response to detecting the change, instructions via the communication network to the second data center, wherein the instructions cause the second data center to obtain the updated second copy of the critical sub-object from the quantum network.

9. The system of claim 1, wherein the computer program code comprises computer instructions configured to cause the processing device to transmit, in response to detecting the change, instructions via the communication network to the second data center, wherein the instructions cause the second data center to clear caches comprising the data object and update the caches to comprise the updated second copy of the critical sub-object.

10. The system of claim 1, wherein the computer program code comprises computer instructions configured to cause the processing device to, when detecting the change to the first copy of the critical sub-object stored in the first data center, detect the change by performing a bell state measurement.

11. The system of claim 1, wherein the computer program code comprises computer instructions configured to cause the processing device to, when detecting the change to the first copy of the critical sub-object stored in the first data center, detect a change in a state of the first copy of the critical sub-object by performing a bell state measurement.

12. The system of claim 1, wherein the computer program code comprises computer instructions configured to cause the processing device to, when updating the second copy of the critical sub-object stored in the second data center, control a clock speed in the quantum network such that a state of the second copy of the critical sub-object matches the state of the first copy of the critical sub-object.

13. The system of claim 1, wherein the data object comprises data associated with a user, wherein the critical sub-object comprises a balance of an account associated with the user, and wherein the change to the first copy of the critical sub-object comprises the user conducting a transaction that alters the balance of the account.

14. The system of claim 1, wherein the data object comprises data associated with a user, wherein the critical sub-object comprises a balance of an account associated with the user, and wherein the change to the first copy of the critical sub-object comprises processing of a transaction that alters the balance of the account.

15. A computer program product for managing states of data objects using entanglement in a quantum network, the computer program product comprising a non-transitory computer-readable medium comprising code causing an apparatus to:
identify, for a data object comprising sub-objects, a critical sub-object of the data object, wherein a first data center stores a first copy of the data object comprising a first copy of the critical sub-object, and wherein a second data center stores a second copy of the data object comprising a second copy of the critical sub-object;
entangle, using a first network interface and in response to identifying the critical sub-object, the first copy of the critical sub-object and the second copy of the critical sub-object on a quantum network, wherein the first network interface is configured to communicate via the quantum network;
detect, using a second network interface, a change to the first copy of the critical sub-object stored in the first data center, wherein the second network interface is configured to communicate via a communication network; and
update, using the first network interface and in response to detecting the change, the second copy of the critical sub-object stored in the second data center via the quantum network to implement the detected change.

16. The computer program product of claim 15, wherein the non-transitory computer-readable medium comprises code causing the apparatus to identify additional critical sub-objects of a plurality of objects having copies stored on a plurality of data centers comprising the first data center and the second data center.

17. The computer program product of claim 15, wherein the first data center provides access to data objects for applications executed by a first plurality of devices located in a first geographical region, and wherein the second data center provides access to the data objects for the applications executed by a second plurality of devices located in a second geographical region that is different from the first geographical region.

18. The computer program product of claim 15, wherein the first data center provides access to data objects for applications executed by a first plurality of devices of a first type, and wherein the second data center provides access to the data objects for the applications executed by a second plurality of devices of a second type that is different from the first type.

19. The computer program product of claim 15, wherein the first data center provides access to data objects for first applications, and wherein the second data center provides access to the data objects for second applications that are different from the first applications.

20. A method for managing states of data objects using entanglement in a quantum network, the method comprising:
identifying, for a data object comprising sub-objects, a critical sub-object of the data object, wherein a first data center stores a first copy of the data object comprising a first copy of the critical sub-object, and wherein a second data center stores a second copy of the data object comprising a second copy of the critical sub-object;
entangling, using a first network interface and in response to identifying the critical sub-object, the first copy of the critical sub-object and the second copy of the critical sub-object on a quantum network, wherein the first network interface is configured to communicate via the quantum network;
detecting, using a second network interface, a change to the first copy of the critical sub-object stored in the first data center, wherein the second network interface is configured to communicate via a communication network; and
updating, using the first network interface and in response to detecting the change, the second copy of the critical sub-object stored in the second data center via the quantum network to implement the detected change.
